(19) United States
(12) Patent Application Publication
(10) Pub. No.: US 2023/0260066 A1
(43) Pub. Date: Aug. 17, 2023

(54) SYSTEM AND METHOD FOR RAPID STUDENT VERIFICATION

(71) Applicant: OCAS, Guelph (CA)

(72) Inventors: Jaime Andres Valencia SALAZAR, Kitchener (CA); Saheem Shahabuddin MUKADDAM, Kitchener (CA); Renita VASWANI, Etobicoke (CA); Wayne Edward Jason HESCH, Waterloo (CA); Dennis Neil GIESBRECHT, Guelph (CA); Oana LOPEZ RODRIGUEZ, Guelph (CA); Mathew Bradley KNOTT, Guelph (CA); Eliza JEYAKUMAR, Waterloo (CA); Nipun SHARMA, Waterloo (CA); Michael ALDWORTH, Guelph (CA); Christopher BUCKLEY, Guelph (CA)

(21) Appl. No.: 18/168,535

(22) Filed: Feb. 13, 2023

Related U.S. Application Data
(60) Provisional application No. 63/309,187, filed on Feb. 11, 2022.
(60) Provisional application No. 63/410,204, filed on Sep. 26, 2022.

(51) Int. Cl. G06Q 50/20

(52) U.S. Cl. CPC G06Q 50/2053

(57) ABSTRACT

A system and method for rapid student verification using an online verification service for IRCC and CBSA officers to verify acceptance details quickly and easily for study permit applicants to one of the colleges using IAS. The solution can be easily accessed by IRCC and CBSA officers at using a website, where they will find a simple and straightforward lookup page and results, available in English and French.

### CROSS REFERENCE TO RELATED APPLICATIONS

This application claims priority to and the benefit of U.S. Provisional Patent Application Ser. No. 63/309187, entitled “SYSTEM AND METHOD FOR RAPID STUDENT VERIFICATION”, filed on Feb. 11, 2022, and U.S. Provisional Patent Application Ser. No. 63/410204, entitled “SYSTEM AND METHOD FOR RAPID STUDENT VERIFICATION”, filed on Sep. 26, 2022, the disclosures of which is incorporated herein by reference in its entirety.

### BACKGROUND

The embodiments described herein relate to student verification for applying for education admissions.

International Applicants require a study permit in order to study in Canada. The study permit application is processed/reviewed by Immigration Refugees Citizenship Canada (IRCC) or overseas embassy/consulate offices, or “High Commissions”, which are affiliated with the Canadian government; when the applicant arrives in Canada at a Port of Entry (POE), the study permit is reviewed and finalized by Canada Border Services Agency (CBSA), and granted if the applicant meets the requirements and criteria. One component of the study permit application that the applicant must provide is proof of a Letter of Acceptance from a recognized college or university, along with proof of adequate payment (tuition).

Currently, when IRCC or CBSA has questions about particular applicants while they are doing their processing, they need to contact the individual college by phone or email, in order to verify the applicant's enrollment and offer status, which can be time-consuming and inefficient, and may delay the processing. As well, the current process is heavily reliant on printed or digital documents which can be easily manipulated in an attempt to get into the country illegally. Payment receipts can also be easily forged. Since IRCC and CBSA don't have the resources to look up every applicant, it's common for people to arrive in Canada, or have their study permit granted, with illegal documents, without authorities discovering the fraud for several months or years.

There is a desire to implement a solution to allow users from these government branches to look up applicants quickly and easily to the colleges in order to verify the applicant's offer status at that college (or university), so that they may make an informed decision in their processing. Additionally, in the cases of mismatching information, there is a desire to identify and report suspected cases of fraud to the DLI or appropriate authorities sooner, and prevent illegal immigration.

### SUMMARY

A system and method for rapid student verification using an online verification service for IRCC and CBSA officers to verify acceptance details quickly and easily for study permit applicants to an institution, ideally one of the institutions using OCAS' International Application Service (IAS). The solution can be easily accessed by IRCC and CBSA officers by using a website, where they will find a simple and straightforward lookup page and results, available in English and French.

The lookup page has been designed to balance privacy, security, and ease of use, with the view to minimize the time taken by IRCC/CBSA officers to enter information, while also mitigating the risk of brute force attacks and ensuring confidential student information is protected.

### BRIEF DESCRIPTION OF THE DRAWINGS

FIG. 1 is a diagram illustrating an exemplary process for applicant verification.

FIG. 2 is a screenshot illustrating an exemplary international applicant verification system.

FIG. 3 is a further screenshot illustrating an exemplary international applicant verification system illustrating a search result.

FIG. 4 is a screenshot illustrating an input screen of an exemplary international applicant verification system.

FIG. 5 is a further screenshot illustrating a results found screen of an exemplary international applicant verification system.

FIG. 6 is a further screenshot illustrating a no valid offers screen of an exemplary international applicant verification system.

FIG. 7 is a diagram illustrating an exemplary scenario.

FIGS. 8A to 8D are screenshots from IAS that illustrate examples of Matching Paid or Pre-Reg Offer Found.

FIG. 9A is a screenshot that illustrates an example of Applicant using LOA, without payment—No Valid Offer in IAS.

FIG. 9B is a screenshot that illustrates an example of Applicant using LOA, without payment—No Valid Offer in OCAS Verify.

FIGS. 10A to 10D are screenshots that illustrate examples of Applicant Not Found—Offer and LOA in IAS.

FIG. 11 is a screenshot illustrating an example Applicant Not Found—Modified Offer Letter.

FIG. 12 is a diagram that illustrates an exemplary OCAS Verify solution.

FIG. 13 is diagram illustrating an alternate OCAS Verify solution.

FIG. 14 is a diagram illustrating an exemplary international applicant verification system using blockchain.

FIG. 15 is a screenshot illustrating an example partial match in OCAS Verify.

FIG. 16 is a workflow diagram that illustrates OCAS Verify future considerations.

### DETAILED DESCRIPTION

References throughout to IAS should be taken to also apply to similar educational institution application systems.

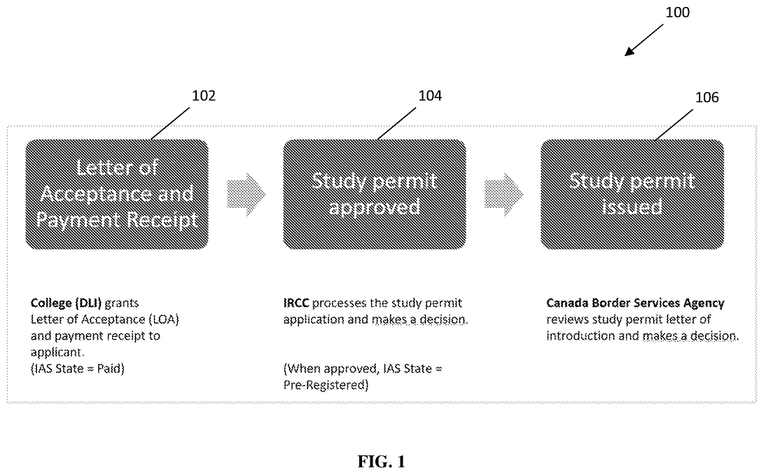

FIG. 1 is a diagram illustrating an exemplary process for applicant verification. According to FIG. 1, the applicant verification process 100 includes steps to check for letter of acceptance and payment receipt 102, whether study permit has been approved 104 and whether study permit is issued 106. In the 1^{st} step (letter of acceptance and payment receipt) 102, the college or designated learning institution (DLI) grants a letter of acceptance (LOA) and payment receipt to the applicant.

According to FIG. 1, in the study permit approved step 104, Immigration Refugees Citizenship Canada (IRCC) processes the study permit application and makes a decision. When OCAS Verify is used by IRCC to confirm the applicant's admission/payment status, this should equate to “Paid” in IAS (institute has confirmed payment from the applicant and instructed them to start their study permit). Then, after approving the study permit app, the applicant should update the state in IAS to “Pre Registered” (study permit application approved). Applicant takes that document from IRCC and goes to Canada to port of entry, and CBSA will review and “grant” the study permit; they can also use OCAS Verify to confirm the applicant's admission and payment status. Ideally, this should map to IAS state of “Pre-Registered” (study permit app was approved by IRCC).

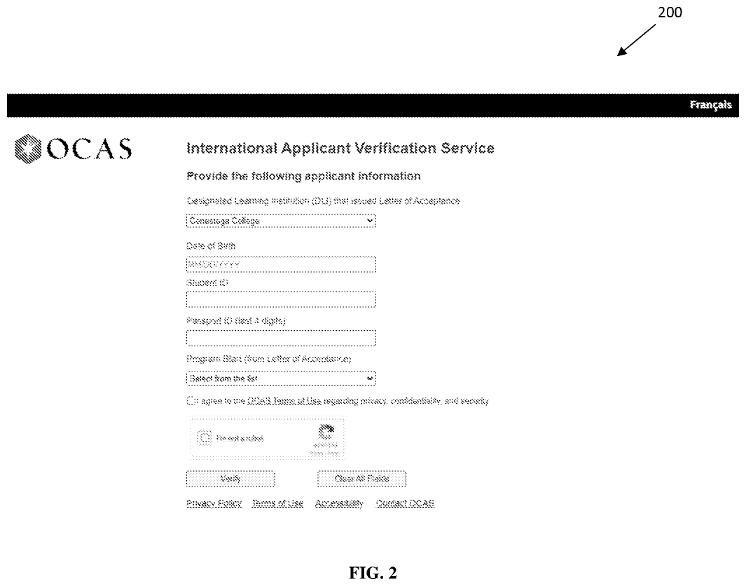

FIG. 2 is a screenshot illustrating an exemplary international applicant verification system. According to FIG. 2, a homepage from a web interface 200 is provided wherein the user is prompt to provide applicant information including designated learning institution (DLI), date of birth, student ID, passport ID and program start date. Once all the info is provided, the user can select the “Verify” button to proceed or “Clear All Fields” button to reset the data entry fields.

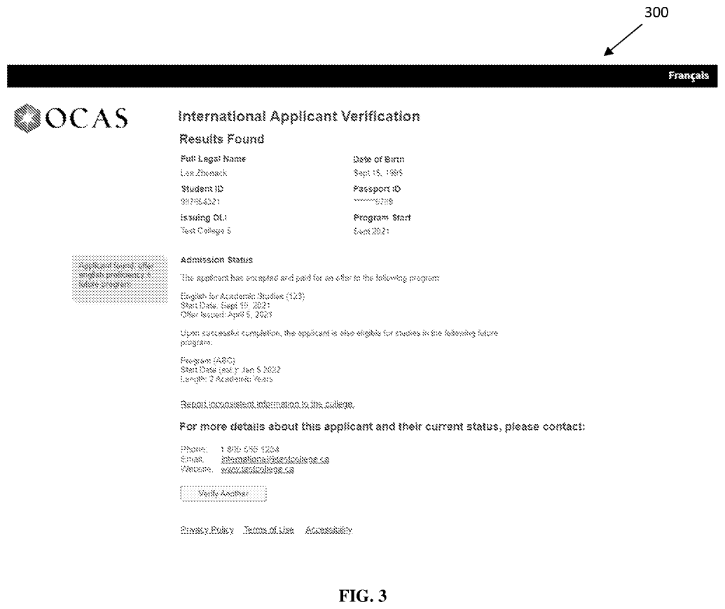

FIG. 3 is a further screenshot illustrating an exemplary international applicant verification system illustrating a search result. According to FIG. 3, exemplary search result screenshot 300 is shown. The results pages have been designed to support multiple ‘match found’ scenarios, for example standard program acceptance, English plus a future program, multiple offers and deferrals, as well as a ‘no match found’ scenario.

How it Works

In one embodiment, the site is designed for access only for users from CBSA and IRCC. In this case, no login is required, and the site URL is not available from the main OCAS nav menu, nor should it be available anywhere else (other than in email correspondence). In another embodiment, the site requires login credentials and/or user authentication.

The site is designed to provide adequate information to users that are involved with approving study permit applications (IRCC) and granting the study permit (Canada Border Services Agency, CBSA), so that they may make an informed decision regarding a study permit application, and if there is discrepancy, they are encouraged to contact the college/university that issued the Letter of Acceptance.

Some countries may have Exit Visa Immigration officials who need to verify an applicant's admission/payment status before they will allow that applicant to leave the country. Those groups (not associated with the Canadian government) could also potentially use the solution. Further, other groups like banks or other countries' own Immigration/Customs groups may find value in the solution as part of investigations they may need to do.

The input form asks for some basic identifiers (without specifically asking the Name); based on this, the site searches for a matching applicant (and displays the name), an offer for the specified time, and optionally payment(s) the institution may have received from that applicant; only offers that are in the specified time (Month/Year) will appear and only offers that are at Paid state or Pre-Registered state:
IRCC will be looking for a positive match on the applicant, and, for an offer at “Paid” state in IAS (Payment verified by the institute).
CBSA will be looking for a positive match on the applicant, and, an offer at “Pre-Registered” state in IAS; this corresponds with “Study Permit application approved”—this state is declared by the Agent/Applicant when they receive the Study Permit approval from IRCC.

The site reads information from a separate data storage from IAS; data from IAS syncs with this new data store periodically. In one embodiment, this period may be twice daily, at 0:00:00 and 12:00:00, UTC (7:00:00 PM and 7:00:00 AM EST). In another embodiment, this period may be hourly.

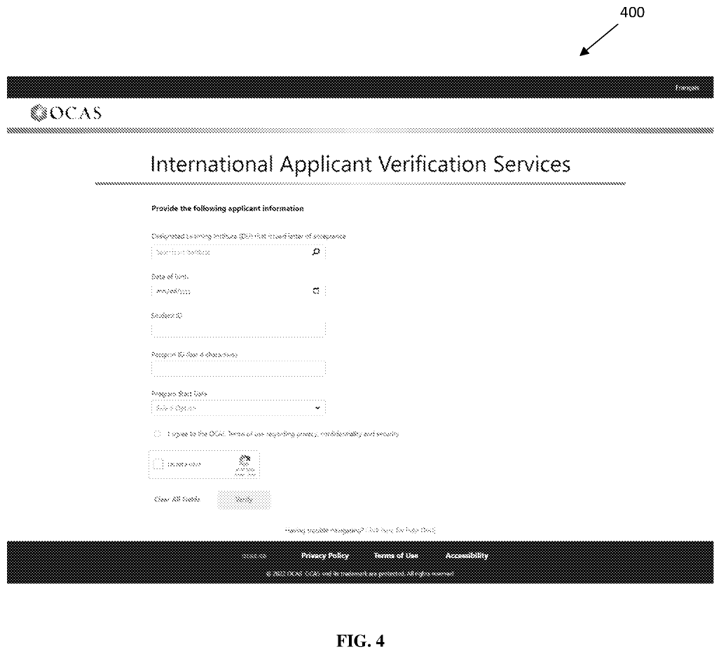

FIG. 4 is a screenshot illustrating an input screen of an exemplary international applicant verification system. According to FIG. 4, exemplary international applicant verification system screenshot 400 shows different parameters. According to FIG. 4, the following input parameters are required (all values must be defined to continue):
Designed Learning Institute (DLI) Name that Issued the Offer Letter
Applicant's Date of Birth
Student ID from the LOA (or, for some institutes, this may be an Applicant ID)
Passport ID: Only the last 4 characters are required
Start Date (for the Program on the Offer Letter): Month/Year

Results

In all cases, it is the end-user's responsibility to verify that the information shown on the results page matches the Letter of Acceptance (LOA) they have and use this information to make an informed decision related to the study permit. If there is significant discrepancy, then users should use their discretion on the appropriate decision and contact the institute for further clarification if in doubt. Users must verify the name that is returned on the results, to what is shown on the Offer Letter.

Results will show only offers that are in the specified term, that are in one of the following states:
Payment verified by the college (Paid in IAS)
Study permit application approved (declared by applicant); (Pre-Registered in IAS)

Applicant Information

It is the end-user's responsibility to verify that the name that appears on the results page matches what is shown on the Letter of Acceptance. If it does not, is the user's responsibility to report this to the respective college/university if they see fit.

Offer Found

Fields for the Offer are as follows:
Program Title (Code)
Campus
DLI Number
Offer Issued Date
Program Start Date
Payment information (if available): Receipt Type, Amount, Date, Confirmation Number

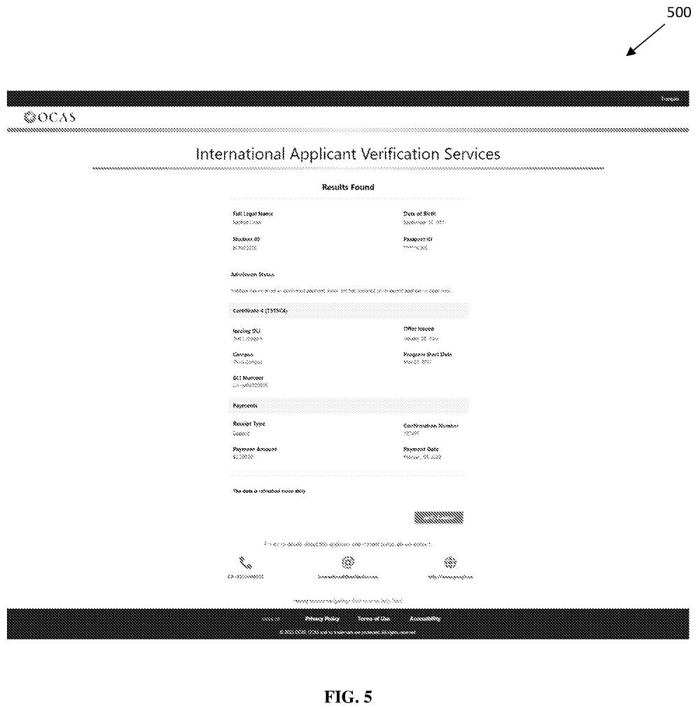

FIG. 5 is a further screenshot illustrating results found screen of an exemplary international applicant verification system. According to FIG. 5, results screenshot 500 is shown. It is the user's responsibility to verify that information shown on the Results page matches the Letter of Acceptance they have. One common gap may be different programs, since sometimes applicants can change programs after they start their study permit application. It is the user's discretion to use this information to make an informed decision on the study permit. All payments for that offer will be shown.

Offer+Future Program

It's common for some colleges to combine multiple programs into one offer; this is sometimes called 1+1, or English Proficiency (EAS, EAP)+Future Program. The purpose is to offer the applicant an extended study period: upon completion of their first program, they may complete studies in a subsequent program, and study in Canada longer. Ideally, the total study length can be determined from this single offer, and the applicant is able to receive a study permit for their full duration of studies. For example, 1 year of English Proficiency, followed by 2 year Diploma in Business, for a total duration of 3 years. However, there's been mixed results from various colleges in terms of the effectiveness of these types of offers, and the success rate from IRCC.

If there is any future program information on an offer (that is in the selected term, and at either Paid or Pre-Registered state), it will appear on the Results page.

Multiple Offers (English+, 1+1)

Other colleges may issue the applicant multiple, separate offers, back-to-back. In these cases, the Results page will show any Paid or Pre-Registered offer that is in the specified term, or in any other future term. Users can then use this information to make an informed decision regarding the applicant's study permit.

No Offer Found in Specified Term—Offer in a Future Term

In rare cases, the applicant may be applying for a study permit with an outdated Letter of Acceptance, or they change their mind in IAS after they have started their study permit application. The most common case is a Deferral. In this scenario, ideally the college has set the Offer state to Deferral Requested, and upon successful processing of the Deferral, will issue a new offer in a future term, and set to Paid (or Pre-Registered). In this case, the Results page will show No offer found, though it will show any offers in any future term at Paid or Pre-Registered state. Instructions will appear to users indicating that institute has issued the Agent/Applicant an updated offer letter, and the Applicant should be able to provide this to IRCC to update their study permit application (adjust the start date).

Applicant Found, No Offer Found in the Specified Term

A matching applicant was found, with the provided name as shown on the results page. However, that applicant does not have a “valid” offer, for a study permit application. (e.g., one in either Paid or Pre-Registered state). In all cases, users are encouraged to contact the institute for further clarification.

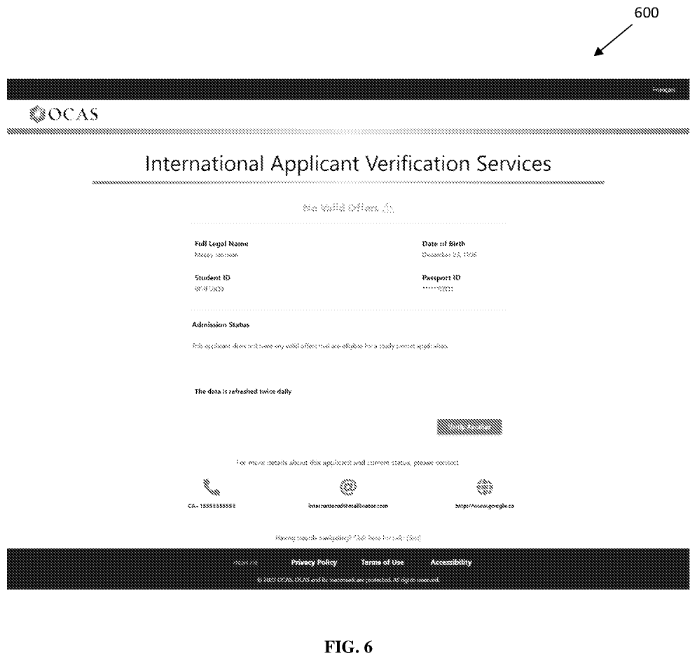

FIG. 6 is a further screenshot illustrating a no valid offers screen of an exemplary international applicant verification system. According to FIG. 6, no valid offer screenshot 600 is shown. There are several possible causes for no valid offers, including:
The applicant has requested a deferral, and the institute has not yet processed it, and the applicant has not updated IRCC with the new information.
The information has not yet been updated on OCAS Verify
Information on the offer letter does not match what is displayed on OCAS Verify (users should contact the institute for further clarification)
The applicant may be attempting to use an offer letter, for an offer state that was not Paid nor Pre-Registered, in order to apply for a study permit application; this could be an offer which was:
   Revoked, due to conditions not met, or payment not received
   Withdrawn, or Declined
   Deferral Requested, Refund Requested
   State Offered, Accepted, and no payment received/confirmed by the college
   A pre-admit/deposit (not for visa purposes) letter—an unofficial Letter of Acceptance, in any Pre-Admit State
   Or the applicant had no offer at all.

Applicant Found, No Offer Found in the Specified Term

In this case, no applicant could be found. In these cases, users are encouraged to contact the institute for further clarification. Possible causes for no applicant found include:
Information was not entered correctly on the input page (type-o)
A matching applicant for the defined input parameters could not be found

Support

The site is designed for users from CBSA and IRCC: however, no login is required. The site URL is not available from the main nav menu, nor should it be available anywhere else (other than in email correspondence). These users are encouraged to contact the specific institution, if they have questions about the results of a particular applicant.

There are currently no restrictions preventing other users from accessing this site; however, the URL is not available on the ocas.ca sites, nor from the navigation menu, the URL will be circulated via emails between college staff, IRCC and CBSA, etc. The site cannot be found via a Google Search.

Questions from Other Users (Agents & Applicants)

These users are encouraged to contact the specific institution, if they have questions about the results of a particular applicant, or the status of their offer, study permit application, etc.

Supported Browsers

If an unsupported web browser is used, the user might experience difficulties. The application works best in the following web browsers:
Firefox—latest version
Chrome—latest version
Microsoft Edge
Safari13+ and iOS 13+

Outages

The site is available 24x7, except for scheduled maintenance.

Reports and Analytics

App Insights has been setup to monitor high level usage. Further, each request and result are logged; this can be useful to provide a college with a detailed summary/report of all requests (in a given week, month). Further, in the case that there is a request from CBSA for information, we should have detailed audit information. ITS can provide a query of information, and export to CSV for further analysis.

Alerts/Blocking IP Address

ITS team should setup alerts of suspicious activity; when something is detected, allow for consideration if that IP Address should be blocked to improve security.

Known Issues

According to the disclosure, some known issues include:

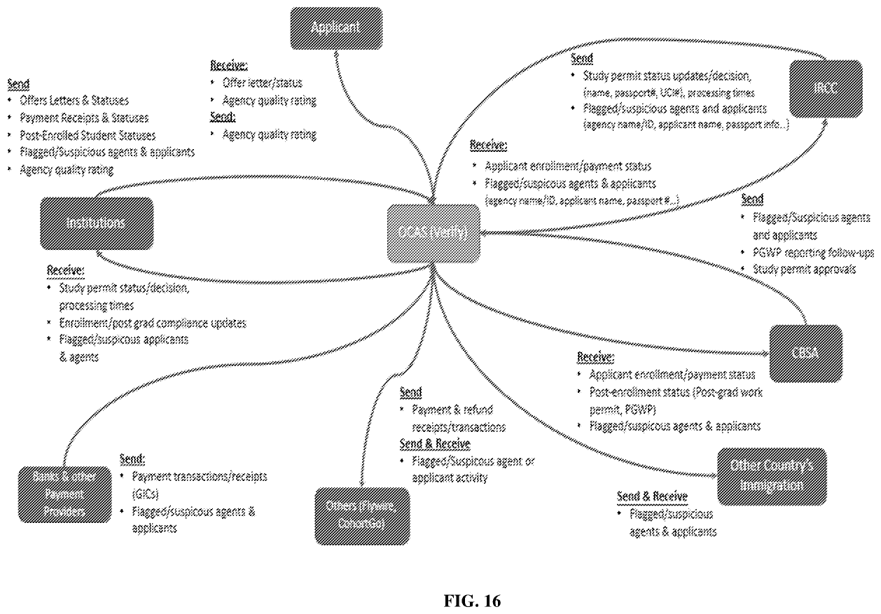

Passports: when an applicant renews their passport, the number can change. Currently, IAS supports only one version of a passport. In a rare case that the applicant's passport number changes between the time the apply on IAS, to their study permit, there may be a disconnect. It's important that this information is consistent, or a mismatch may occur. OCAS Verify handles this situation by showing a partial match on the applicant: DOB and passport match, but not Student ID, as per FIG. 16. Users should then utilize this information to decide if they want to follow up with the institution or make an informed decision regarding processing.

Payments: not all offers will have payments and not all colleges send payment information to IAS, so we cannot show this on the Results page.

In some rare cases, the Student ID on the offer letter may not match what is on the database (shown on the offer details page); the match is ran against the Student ID in the database, and there is only one (most recent) version; if the input params use the Student ID from the LOA which is different, then this will return back a partial match, similar to FIG. 16.

Feedback, VRs, Ideas

Submit tickets, VRs under International Maintenance.

Exemplary Scenario

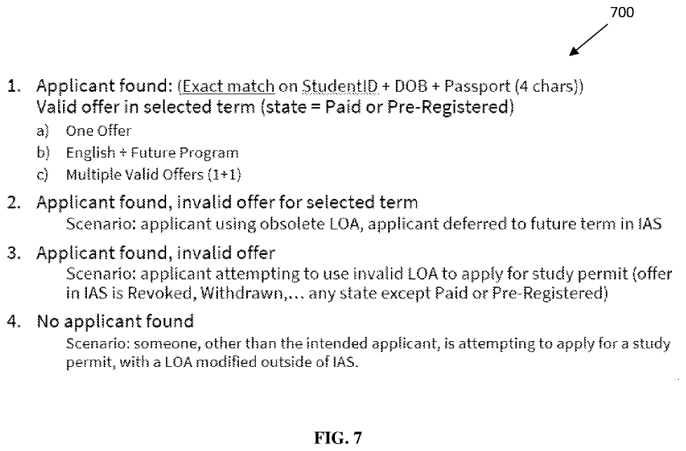

FIG. 7 is a diagram illustrating an exemplary scenario. According to FIG. 7, exemplary scenario 700 is shown indicating the following scenarios:
1) Applicant found: Valid offer in selected term
   One Offer
   English+Future Program
   Multiple Valid Offers
2) Applicant found, invalid offer for selected term
   Applicant using obsolete letter of acceptance (LOA), applicant deferred to future terms in International Application Service (IAS)
3) Applicant found, invalid offer
   Applicant attempting to use invalid letter of acceptance (LOA) to apply for study permit (offer in IAS is revoked, withdrawn, any state except Paid or Pre-registered)
4) No applicant found
   Someone, other than the intended applicant is attempting to apply for a study permit, with a LOA modified outside of IAS

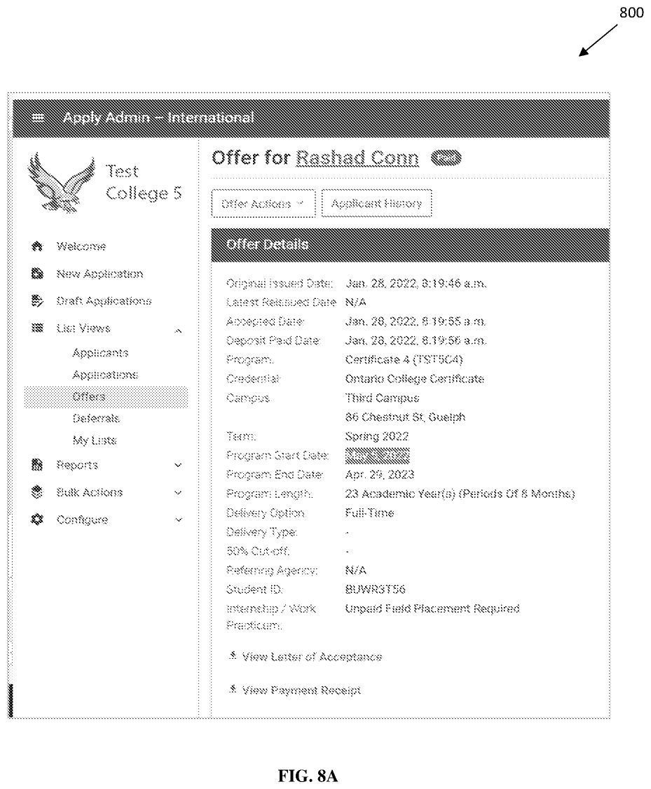

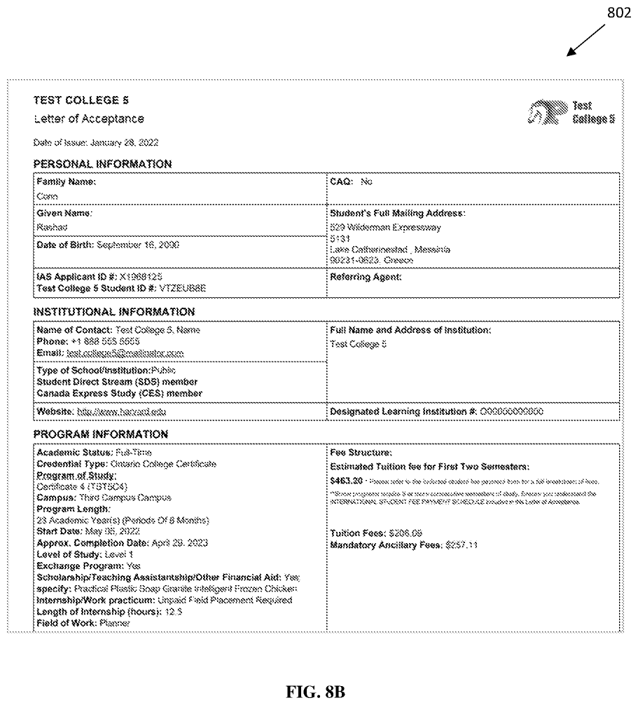

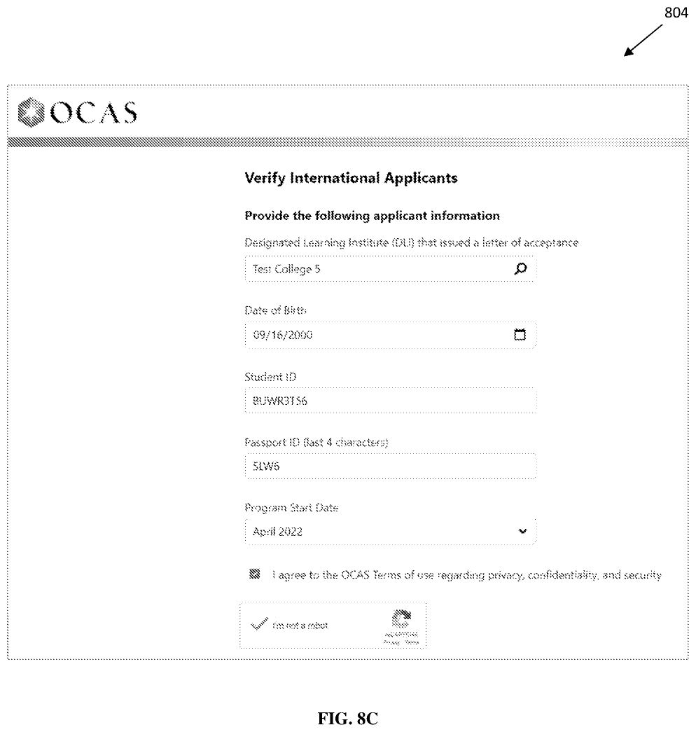

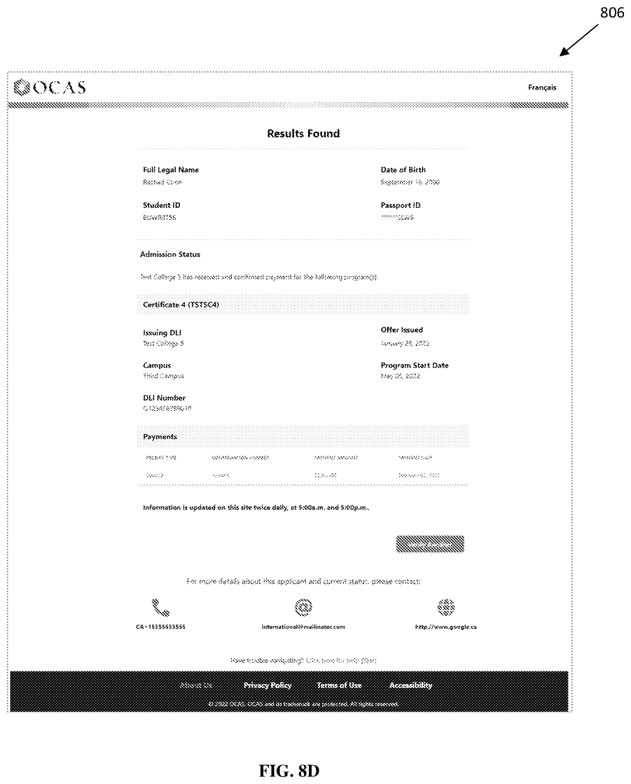

FIGS. 8A to 8D are screenshots that illustrate examples of Matching Paid or Pre-Reg Offer Found. According to FIGS. 8A to 8D, exemplary screenshots 800, 802, 804 and 806 illustrate a letter of acceptance (LOA) offer letter from Test College 5.

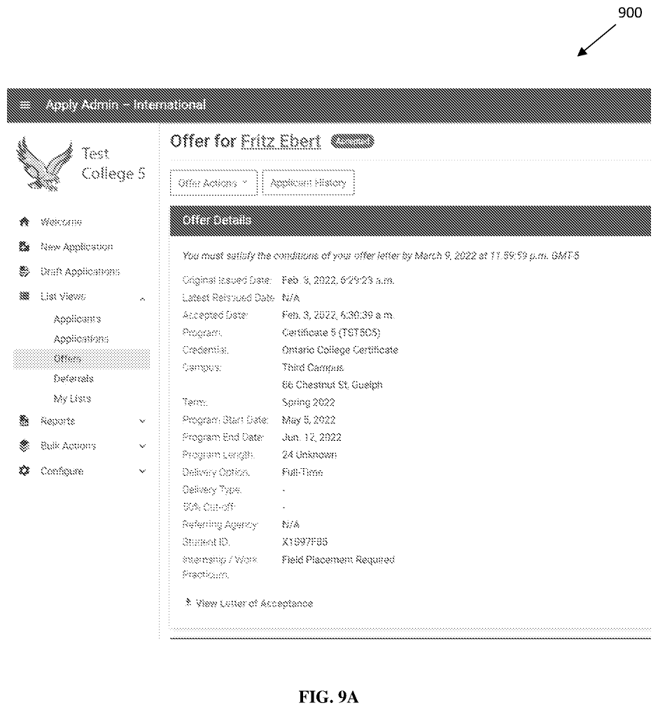

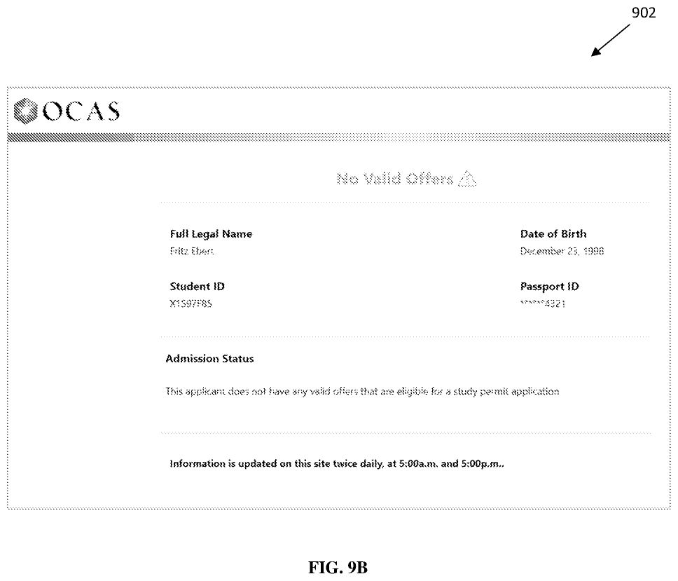

FIGS. 9A to 9B are screenshots that illustrate examples of Applicant using Letter of Acceptance (LOA), without payment—No Valid Offer. According to FIGS. 9A and 9B, exemplary screenshots 900 and 902 illustrating an application receiving a letter of acceptance from Test College 5 with no valid offer.

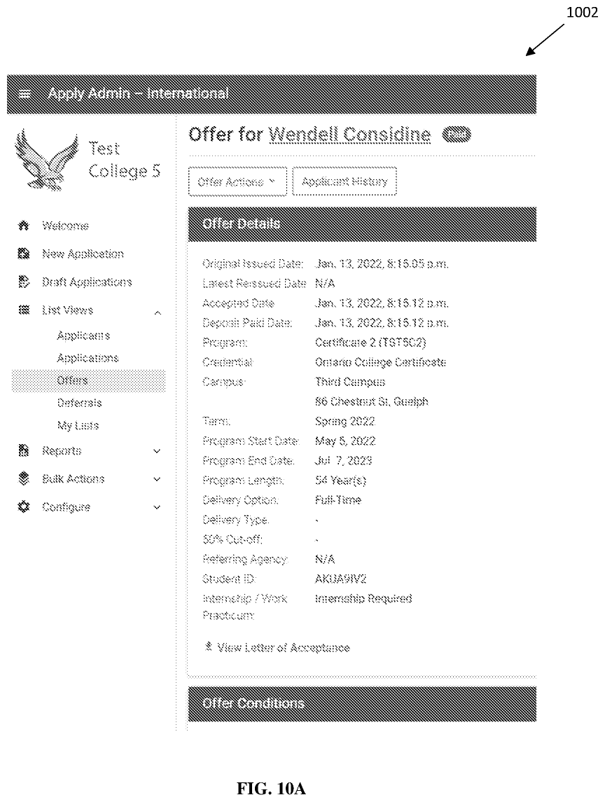

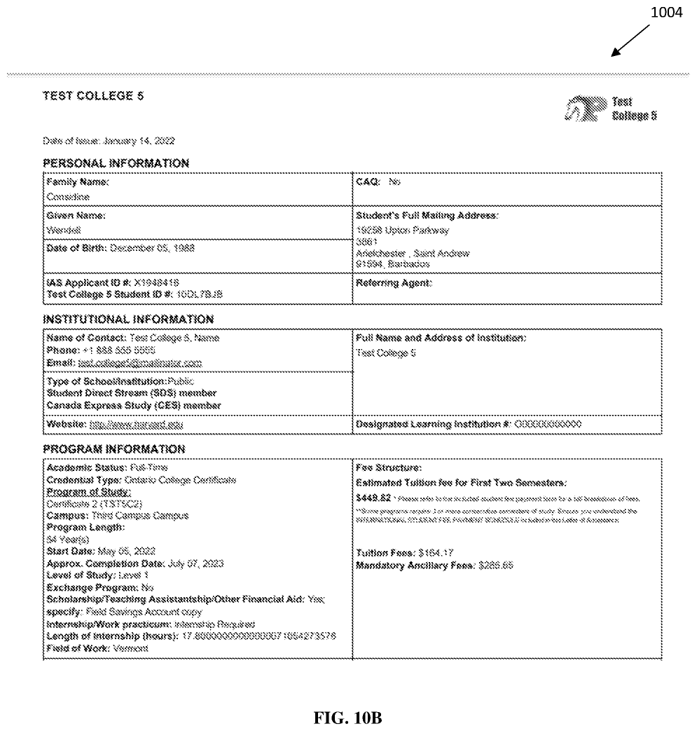

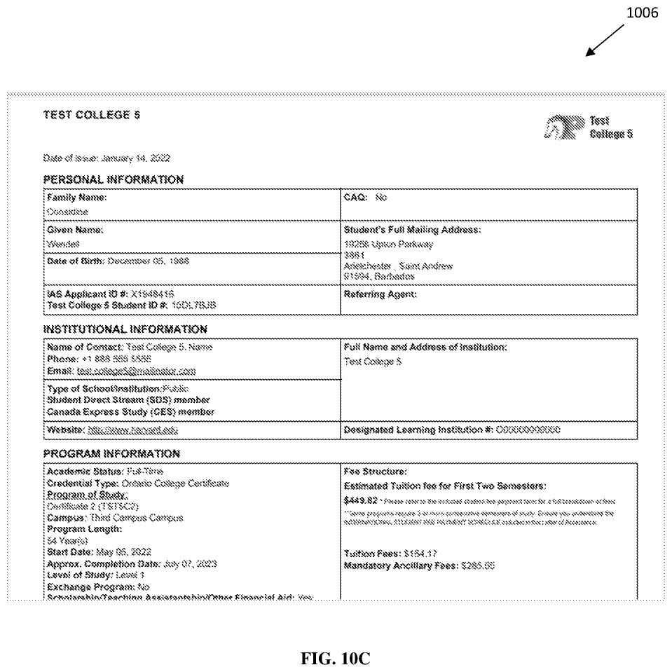

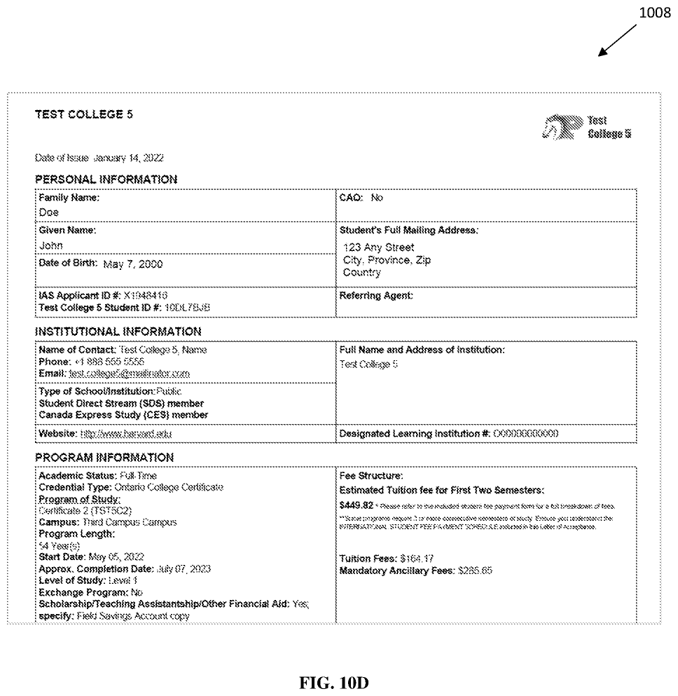

FIGS. 10A to 10D are screenshots that illustrate examples of Applicant Not Found—Offer and Letter of Acceptance (LOA) in the International Application Service (IAS). According to FIGS. 10A to 10D, screenshots 1000, 1002, 1004 and 1008 illustrate different exemplary screenshots that provides results from Test College 5 for Letter of Acceptance (LOA).

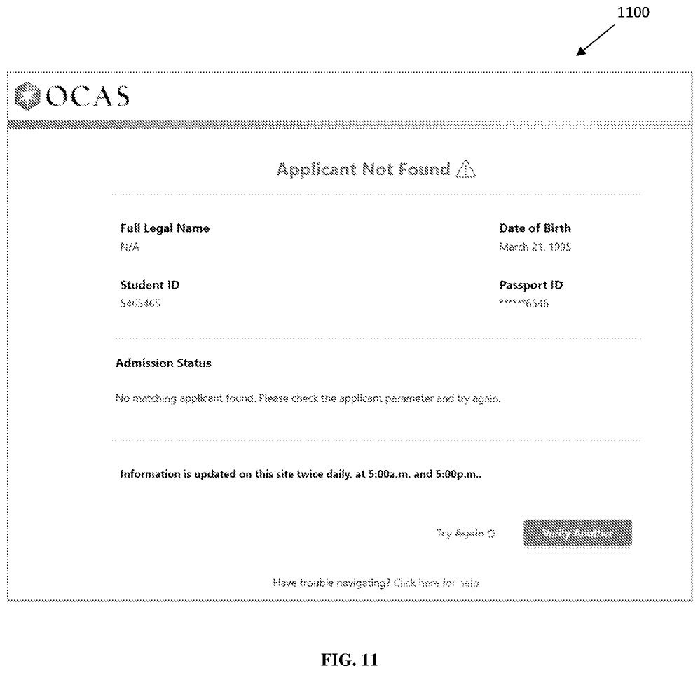

FIG. 11 is a screenshot illustrating an example Applicant Not Found—Modified Offer Letter. According to FIG. 11, an exemplary screenshot 1100 illustrates that the application is not found. The user is prompted to “Try Again” or “Verify Another” application.

The Solution

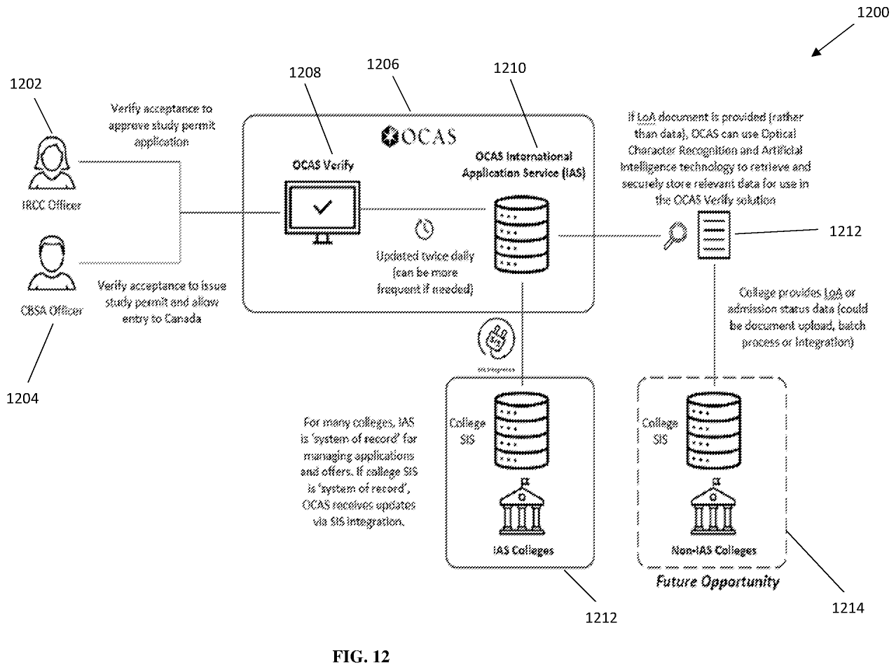

OCAS Verify has been created as a secure online verification service for IRCC and CBSA officers to verify acceptance details quickly and easily for study permit applicants to one of the colleges using IAS. The solution can be easily accessed by IRCC and CBSA officers at www.ocas.ca/verify, where they will find a simple and straightforward lookup page and results, available in English and French. FIG. 12 is a diagram that illustrates an exemplary OCAS Verify solution.

OCAS Verify provides a trusted, safe, and secure solution 1200. According to FIG. 12, an IRCC officer 1202 will verify acceptance to approve study permit applications with the OCAS Verify system 1206. Further a CBSA officer 1204 can verify acceptance to issue study permits and allow for entry into Canada with the OCAS Verify system 1206. The OCAS Verify system 1206 includes the OCAS Verify portal 1208 and an OCAS International Application Service (IAS) 1210 that is updated at least twice daily. Optionally, the OCAS Verify system 1206 may interoperate with another application service which provides similar functionality to IAS or provides a subset of IAS functionality with an associated reduction in the services offered by OCAS Verify for applications processed through this alternative application service.

According to FIG. 12, the OCAS Verify system 1206, or similar solution from OCAS, connects to the college Student Information System (SIS) for IAS 1212 and non-IAS colleges 1214. For many colleges, IAS is a “system of record” for managing applications and offers. The OCAS Verify system receives updates via SIS integration.

According to FIG. 12, the OCAS IAS will provide a letter of acceptance (LoA) 1216. The OCAS Verify system 1206 can use optical character recognition (OCR) and artificial intelligence (AI) technology to retrieve and securely store relevant data for use in the OCAS Verify solution 1200. Further, the colleges can provide the letter of acceptance or admission status data via a document upload, batch processing or integration processing.

The OCAS Verify system 1206 also provides a lookup page that is designed to balance privacy, security, and ease of use, with the view to minimize the time taken by IRCC/CBSA officers (1202, 1204) to enter information, while also mitigating the risk of brute force attacks and ensuring confidential student information is protected.

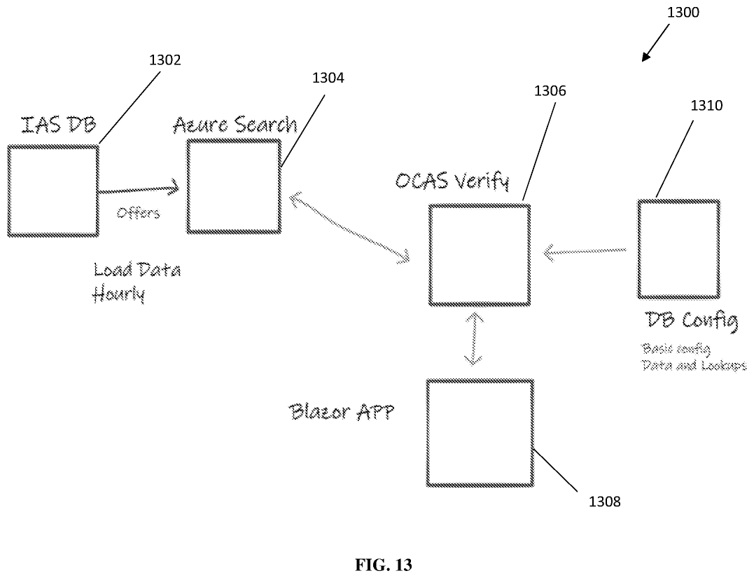

FIG. 13 is diagram illustrating an alternate OCAS Verify system. According to FIG. 13, system 1300 includes the OCAS Verify module 1306 that utilizes an azure search 1304 cognitive index to be able to maintain a highly quick response to any entity that is required for any applicant verification. The system 1300 keep this index updated hourly with the applicant and offer data that are needed to do this verification.

According to FIG. 13, an International Application Service (IAS) database 1302 connects to the Azure Search module 1304 to check on offers where data is loaded in an hourly basis. The OCAS Verify module 1306 has a bi-directional connection to Azure Search module 1304.

The OCAS Verify module 1306 also has a bi-directional connection to the a front-end application 1308. Front-end application 1308 can be the Blazor application using front end technology or other front-end applications configured to communicate bi-directionally with the student verification module 1306. Front-end application 1308 can also provide other information such as demographic information, payment information, passport number based on references to the Blazor application.

Furthermore, the Database Configuration module 1310 that provides for basic configuration data and lookups also connects to the OCAS Verify module 1306 uni-directionally.

Blockchain

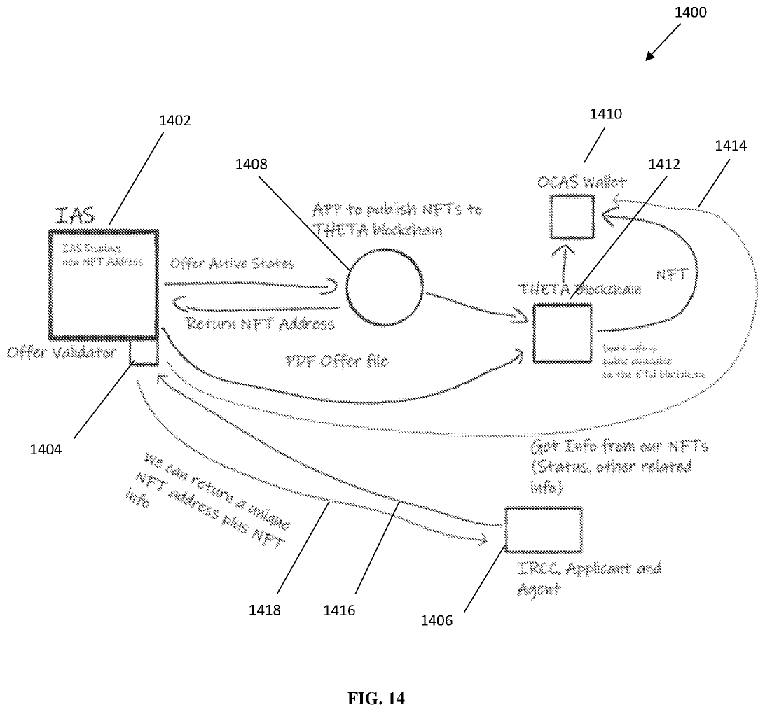

FIG. 14 is a diagram illustrating an exemplary international applicant verification system using blockchain. According to FIG. 14, blockchain system 1400 consists of a non-fungible token (NFT), which holds information about the applicant 1402, is published to a blockchain 1408, and may then be stored in an OCAS wallet 1410. Applicant 1402 includes international application service (IAS) that displays NFT address. Applicant 1402 or IAS also includes a NFT Offer Validator 1404. The NFT may be authenticated as being from a reputable source such as THETA Blockchain 1412. The NFT may therefore provide authenticated and non-refutable proof of the information about the applicant.

The exemplary system shown in FIG. 14 shows one implementation of a blockchain-based applicant information verification system. In another embodiment, a different blockchain may be used. In another embodiment, a different network topology and set of interactions may be used to implement and access an application information verification NFT.

According to FIG. 14, the route line 1 1414 is where the system is making the call on behalf of the applicant. Route line 1414 provides status info from the NFTs including status and other related info. The route line 1416 is where the applicant 1402 and agent 1406 (e.g., IRCC applicant and agent) are interacting with the system.

According to FIG. 14, route line 3 1418 is showing the results to the end user or applicant. Route line 1418 may also return a unique NFT address and other additional NFT info.

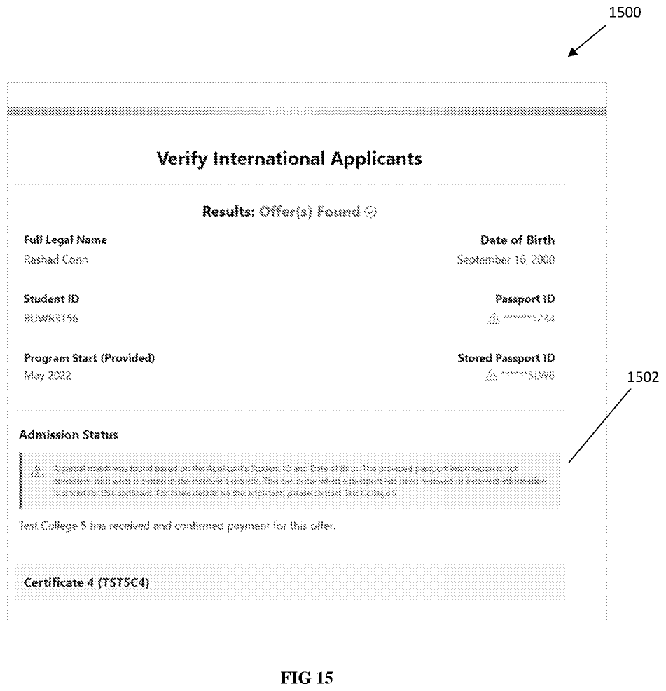

FIG. 15 is a screenshot illustrating an example partial match in OCAS Verify. According to FIG. 15, screenshot 1500 illustrates a partial match for Test College 5. An admission status 1502 is shown providing explanation that a partial match was found based on the Applicant's Student ID and Date of Birth. The provided passport information is not consistent with what is stored in the institution's records. This can occur when a passport has been renewed or incorrect information is stored for this applicant. More information can be provided by contacting the institution (i.e., Test College 5).

Future Evolution

OCAS sees several potential opportunities to enhance the tool beyond the single applicant lookup site, to ensure it continues to deliver value to colleges, IRCC and CBSA, for example:
1. Eliminate the possibility of agents or applicants altering pdf documents. A robust solution for this will be more technical in nature and likely have greater technical and operational impacts on IRCC and CBSA.
2. Use blockchain technologies to improve security, immutability, and traceability—OCAS is currently undertaking deep investigation and planning prototypes to enable future use of blockchain technologies across its products and services.
3. Explore opportunities to provide a more automated mechanism to verify acceptance in bulk before IRCC even starts processing a study permit application.
4. Enable OCAS Verify to be used by colleges who don't currently use IAS—OCAS is currently exploring the use of optical character recognition and artificial intelligence technologies to accurately read and store pertinent information from documents. This capability could be used to allow other colleges to provide Letters of Acceptance issued outside IAS to be included in the OCAS Verify tool.
5. Expand the use case and leverage OCAS' electronic transcript management system (eTMS) to enable verification of course/program completion, transcripts, and credentials to better support students when they apply for work permits.
6. Develop open APIs to improve connectivity with other systems, for example when MyCreds is mature enough to integrate with for this kind of functionality.

Future Considerations

OCAS sees several potential opportunities to enhance the tool beyond the single applicant lookup site, to ensure it continues to deliver value to colleges, IRCC and CBSA, for example:
1. Eliminate the possibility of agents or applicants altering pdf documents. A robust solution for this will be more technical in nature and likely have greater technical and operational impacts on IRCC and CBSA. Electronic document signing and authentication systems, document signatures stored centrally, document signatures stored on a blockchain, or digital rights management systems may be used for this purpose, as might any other system which prevents the unnoticeable alteration of documents.
2. Use blockchain technologies to improve security, immutability, and traceability—OCAS is currently undertaking deep investigation and planning prototypes to enable future use of blockchain technologies across its products and services.
3. Explore opportunities to provide a more automated mechanism to verify acceptance in bulk before IRCC even starts processing a study permit application. This may include providing IRCC/CBSA with the data related to offers, and using technologies such as Document Hash ID's, to allow IRCC/CBSA to compare the Hash ID in their digital document (Letter of Acceptance) to what is stored in OCAS (the source of truth), and in the case of any differences, flag this immediately as a potential case where an offer letter has been manipulated. Secure API's can also be used as a data exchange mechanism.
4. Enable OCAS Verify to be used by colleges who don't currently use IAS—OCAS is currently exploring the use of optical character recognition and artificial intelligence technologies to accurately read and store pertinent information from documents. This capability could be used to allow other colleges to provide Letters of Acceptance issued outside IAS to be included in the OCAS Verify tool.
5. Expand the use case and leverage OCAS' electronic transcript management system (eTMS) to enable verification of course/program completion, transcripts, and credentials to better support students when they apply for work permits.
6. Develop open APIs to improve connectivity with other systems, for example when MyCreds is mature enough to integrate with for this kind of functionality.
7. Allow the rating or flagging of application agents who have engaged in undesirable or unacceptable practices, such as document forgery or negligence in applicant authentication. This capability may allow for the creation of a trust score for an application, with higher trust scores needing less intensive verification. These ratings, flags or scores may be shared with IRCC or CBSA to allow for reduced or increased screening of applicants based on a number of factors. IRCC/CBSA information on inaccurate, negligent or fraudulent applications or applicants, or the information that an applicant has been denied a study permit, may be shared back to the OCAS Verify system to allow for the creation of a score based on the aggregation of such information.
8. Allow the sharing of information, from the IRCC or CBSA to OCAS, that an applicant has been denied a study permit in Canada or elsewhere. This capability may allow OCAS to inform an institution that the applicant may not be able to attend a program to which they have been accepted.
9. Allow the sharing of information, from the IRCC or CBSA to OCAS, that an applicant has been issued a study permit, that a background check has been performed on the applicant, that the applicant has arrived in Canada, or that some other status change or applicant update may be available. The availability of this information may allow for institutions to better plan for how many students will be in class when a semester begins.
10. Allow the sharing of information, from OCAS to IRCC or CBSA, that a person is or is not registered at an institution, to allow CBSA to screen for applicants using fraudulent paperwork upon arriving in Canada.
11. Ensure that the sharing, storing and accessibility of any applicant information is subject to privacy legislation and privacy rights, and appropriately balances system benefits and efficiencies with the privacy needs/desires of applicants.

FIG. 16 is a workflow diagram that illustrates OCAS Verify future considerations further elaborating what is sent and received by each party. According to FIG. 16, the OCAS Verify system communicates bi-directionally with each party with the following information:

Institutions:
Send
   Offers Letters & Statuses
   Payment Receipts & Statuses
   Post-Enrolled Student Statuses
   Flagged/Suspicious agents & applicants
   Agency quality rating
Receive
   Study permit status/decision, processing times
   Enrollment/post grad compliance updates
   Flagged/suspicious applicants & agents

Applicant:
Send
   Agency quality rating
Receive
   Offer letter/status
   Agency quality rating

IRCC:
Send
   Study permit status updates/decision, (name, passport#, UCI#), processing times
   Flagged/suspicious agents and applicants (agency name/ID, applicant name, passport info. . . )
Receive
   Applicant enrollment/payment status
   Flagged/suspicious agents & applicants (agency name/ID, applicant name, passport #. . . )

CBSA
Send
   Flagged/Suspicious agents and applicants
   PGWP reporting follow-ups
   Study permit approvals
Receive
   Applicant enrollment/payment status
   Post-enrollment status (Post-grad work permit, PGWP)
   Flagged/suspicious agents & applicants

Other Country's Immigration:
Send
   Flagged/Suspicious agents & applicants
Receive
   Flagged/suspicious applicants & agents

Banks & Other Payment Providers:
Send
   Payment transactions/receipts (GICs)
   Flagged/suspicious agents & applicants

Others (Flywires, CohortGo):
Send
   Payment & refund receipts/transactions
Receive
   Flagged/Suspicious agent or applicant activity

According to the disclosure, a computer-implemented method for international student admissions application verification, using an international application service (IAS) is disclosed. The method comprises the steps of receiving an international application from an international applicant, processing an international application by a first government agency, approving the international application from the international student, changing the status of the application in the IAS to a pre-registered status, reviewing the international application to issue a study permit by a second government agency, approving a study permit by a second government agency and issuing a study permit for the international student by a second government agency.

According to the disclosure, the first and second government agencies are the same agency. The first agency is an immigration department, such as Immigration Refugees Citizenship Canada (IRCC). The second agency is a border security agency, such as Canada Border Services Agency (CBSA).

According to the disclosure, the pre-registered status of the method is “pre-registered”. The lookups of the method can be conducted in French or English.

According to the disclosure, a computer-implemented system to verify international student admissions for one or more academic institutions is disclosed. The system comprises a student verification system, further comprising, an international application service (IAS), a verification portal and an academic student Information System (SIS) associated with the one or more academic institution.

According to the disclosure, acceptance of study permit application of the system is provided by a nation's immigration officer. The acceptance to issue a study permit and allow entry into the nation of the system is provided by a nation's border security office.

According to the disclosure, the international application service (IAS) of the system is configured to support academic institutions IAS enabled colleges. The academic student Information System (SIS) of the system exchanges information with the student verification system to exchange data and update system of record to manage applications and offers. The academic student Information System (SIS) of the system provides letter of acceptance (LoA) or admission status to the student verification system.

According to the disclosure, the international application service (IAS) of the system further supports non-enabled IAS colleges. The verification portal communicates with the international application service (IAS) and updates records at least twice daily.

According to the disclosure, the student verification system utilizes optical character recognition (OCR) to retrieve and securely store relevant data. Furthermore, the student verification system utilizes artificial intelligence (AI) to retrieve and securely store relevant data. The academic student Information System (SIS) of the system provides letter of acceptance (LoA) or admission status data as a document upload, batch process or integration process.

According to the disclosure, a computer-implemented system to verify international student admissions for one or more academic institutions is disclosed. The computer-implemented system comprises a student verification module, an Azure search module configured for bi-directional communication with the student verification module, an international application service (IAS) database configured to provide offer or admissions data to the Azure search module, a database configuration module configured to provide basic configuration data and lookups to the OCAS Verify module 1306 uni-directionally and a front-end application module configured to communicate bi-directionally with the student verification module.

According to the disclosure, the student verification module of the computer-implemented system receives offer data from the IAS database and Azure Search module, configuration data and lookups from the database configuration module and other info from the front-end application module and compiles all this info to provide a student admissions assessment.

According to the disclosure, the international application service (IAS) database of the computer-implemented system loads data hourly and provides to Azure search module. Furthermore the student admissions assessment of the computer-implemented system is saved into a verification module database. Finally, a letter of acceptance is sent to the student.

The functions described herein may be stored as one or more instructions on a processor-The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A computer-implemented method for international student admissions application verification, using an international application service (IAS), comprising the steps of:
receiving an international application from an international applicant;
processing an international application by a first government agency;
approving the international application from the international student;
changing the status of the application in the IAS to a pre-registered status;
reviewing the international application to issue a study permit by a second government agency;
approving a study permit by a second government agency; and
issuing a study permit for the international student by a second government agency.

2. The method of claim 1 wherein the first and second government agencies are the same agency.

3. The method of claim 1 wherein the first agency is an immigration department, such as Immigration Refugees Citizenship Canada (IRCC).

4. The method of claim 1 wherein the second agency is a border security agency, such as Canada Border Services Agency (CBSA).

5. The method of claim 1 wherein the pre-registered status is “pre-registered”.

6. The method of claim 1 where wherein lookups can be conducted in French or English

7. A computer-implemented system to verify international student admissions for one or more academic institutions, comprising:
a student verification system, further comprising:
an international application service (IAS);
a verification portal;
an academic student Information System (SIS) associated with the one or more academic institution;
wherein acceptance of study permit application is provided by a nation's immigration officer;
wherein acceptance to issue a study permit and allow entry into the nation is provided by a nation's border security officer;
wherein the international application service (IAS) is configured to support academic institutions IAS enabled colleges;
wherein the academic student Information System (SIS) exchanges information with the student verification system to exchange data and update system of record to manage applications and offers; and
wherein the academic student Information System (SIS) provides letter of acceptance (LoA) or admission status to the student verification system.

8. The system of claim 7 wherein the international application service (IAS) further supports non-enabled IAS colleges.

9. The system of claim 7 wherein the verification portal communicates with the international application service (IAS) and updates records at least twice daily.

10. The system of claim 7 wherein the student verification system utilizes optical character recognition (OCR) to retrieve and securely store relevant data.

11. The system of claim 7 where in the student verification system utilizes artificial intelligence (AI) to retrieve and securely store relevant data.

12. The system of claim 7 wherein the academic student Information System (SIS) provides letter of acceptance (LoA) or admission status data as a document upload, batch process or integration process.

13. A computer-implemented system to verify international student admissions for one or more academic institutions, comprising:
a student verification module;
an Azure search module configured for bi-directional communication with the student verification module;
an international application service (IAS) database configured to provide offer or admissions data to the Azure search module;
a database configuration module configured to provide basic configuration data and lookups to the OCAS Verify module 1306 uni-directionally; and
a front-end application module configured to communicate bi-directionally with the student verification module;
wherein the student verification module receives offer data from the IAS database and Azure Search module, configuration data and lookups from the database configuration module and other info from the front-end application module and compiles all this info to provide a student admissions assessment.

14. The system of claim 13 wherein international application service (IAS) database loads data hourly and provides to Azure search module.

15. The system of claim 13 wherein the student admissions assessment is saved into a verification module database.

16. The system of claim 13 wherein a letter of acceptance is sent to the student.
